(19) United States
(12) Patent Application Publication
(10) Pub. No.: US 2013/0175006 A1
(43) Pub. Date: Jul. 11, 2013

(54) HYDROGEN TRANSFER HEATING/COOLING SYSTEMS AND METHODS OF USE THEREOF

(71) Applicants: Kyle W. ROBINSON, San Antonio, TX (US); Jerry A. HENKENER, Canyon Lake, TX (US); Marshall L. Nuckols, Panama City, FL (US)

(72) Inventors: Kyle W. ROBINSON, San Antonio, TX (US); Jerry A. HENKENER, Canyon Lake, TX (US); Marshall L. Nuckols, Panama City, FL (US)

(73) Assignee: SOUTHWEST RESEARCH INSTITUTE, SAN ANTONIO, TX (US)

(21) Appl. No.: 13/344,797

(22) Filed: Jan. 6, 2012

(51) Int. Cl. C09K 5/16; F28D 15/00; F17C 11/00; B67D 7/80; F25B 29/00

(52) U.S. Cl. 165/104.12; 222/3; 222/146.1; 165/48.1; 206/7

(57) ABSTRACT

A system is provided to change a temperature of an environment. A first plurality of containers store metal hydride, while a second plurality of containers store metal alloy capable of absorbing hydrogen atoms at a pressure less than a storage pressure of the metal hydride. Valved conduits link container pairs of metal hydride and metal alloy. When the valves are opened, hydrogen atoms desorbed from the metal hydride are transported through the conduit and are absorbed by the metal alloy. Desorption of the hydrogen cools the metal hydride containing container and heats the metal alloy containing container, which are each in thermal communication with the environment to cool or heat the environment via fluid circulation means. One or more container pairs may be operated to cool/heat the environment, while one or more other container pairs may be regenerated using a renewable power source.

### GOVERNMENT FUNDING

This invention was made with government funding under contract with the U.S. Navy Experimental Diving Unit (NEDU), Government Prime Contract Number N0463A-09-C-0001, Purchase Order Number N0463A09RQ24001. The Government has certain rights in this invention.

### FIELD

The present disclosure relates generally to heating and/or cooling systems involving hydrogen transfer, and more particularly to hydrogen transfer based systems wherein the systems may be operated continuously and indefinitely to heat and/or cool human-occupied environments, particularly wherein reactants of the system may be regenerated using a renewable energy source.

### BACKGROUND

Human-occupied, man-made environments that are used or immersed in harsh ambient environments may require heating and/or cooling in order to provide safe and comfortable temperature conditions for their human occupant(s). For example, garments worn by divers, firefighters, chemical “hazmat” workers, and others frequently may be heated and/or cooled depending on ambient environmental conditions. In addition, small chambers such as dive chambers or hyperbaric chambers may also be heated and/or cooled. Furthermore, even larger, closed, man-made environments may require heating and/or cooling, such as space stations used in outer space.

In each of these cases, constraints on size, weight, power availability and/or power consumption limit the types of heating and/or cooling systems that can be used. Furthermore, since some applications of these human-occupied environments may require heating while other applications may require cooling, it is advantageous to have a single system that is capable of being configured for heating and/or cooling as dictated by the particular application conditions.

Additionally, such heating and/or cooling systems may be required to operate continuously and indefinitely to heat or cool human-occupied environments, as well as be rechargeable, particularly using a renewable energy source.

### SUMMARY

Accordingly, it is an object of the present disclosure to provide a system for effecting temperature changes.

Another object of the present disclosure is to provide a system that may be configured to heat and/or cool an environment, such as a man-made, human-occupied closed environment.

Still another object of the present disclosure is to provide a system that may be configured to heat and/or cool the environment on a continuous basis for an indefinite period of time.

Still another object of the present disclosure is to provide a system that may be rechargable, and more particularly configured to regenerate reactants of the system from a reaction product of the system using a renewable energy source.

Still another object of the disclosure is to provide a system for effecting temperature change in an environment, with the system comprising: a plurality of container apparatus pairs, each container apparatus pair including a first container apparatus comprising a first container to store a metal hydride therein at a storage pressure greater than ambient pressure, and a first heat exchanger in thermal communication with the first container; a second container apparatus comprising a second container to store a metal alloy therein, the metal alloy being capable of absorbing hydrogen atoms at a pressure less than the storage pressure of the metal hydride, and a second heat exchanger in thermal communication with the second container; a conduit coupled between the first container and the second container, the conduit in communication with the metal hydride and in communication with the metal alloy; a valve disposed in the conduit for controlling communication between the metal hydride and the metal alloy; a first fluid circulation means comprising a first fluid flow passage to contain a first fluid, the first fluid circulation means arranged to operate with the environment and the first heat exchangers of the container apparatus pairs the first fluid flow passage being arranged for the first fluid to pass through the environment and selectively modifiable for the first fluid to pass through one or more of the first heat exchangers; a second fluid circulation means comprising a second fluid flow passage to contain a second fluid, the second fluid circulation means arranged to operate with the environment and the second heat exchangers of the container apparatus pairs; the second fluid flow passage being arranged for the second fluid to pass through the environment and selectively modifiable for the second fluid to pass through one or more of the second heat exchangers.

Still another object of the disclosure is to provide a method for effecting temperature change in an environment, with the method comprising: providing a system to effect temperature change, comprising: a plurality of container apparatus pairs, each container apparatus pair including a first container apparatus comprising a first container to store a metal hydride therein at a storage pressure greater than ambient pressure, and a first heat exchanger in thermal communication with the first container; a second container apparatus comprising a second container to store a metal alloy therein, the metal alloy being capable of absorbing hydrogen atoms at a pressure less than the storage pressure of the metal alloy, and a second heat exchanger in thermal communication with the second container; a conduit coupled between the first container and the second container, the conduit in communication with the metal hydride and in communication with the metal alloy; a valve disposed in the conduit to control communication between the metal hydride and the metal alloy; a first fluid circulation means comprising a first fluid flow passage to contain a first fluid, the first fluid circulation means arranged to operate with the environment and the first heat exchangers of the container apparatus pairs; the first fluid flow passage being arranged for the first fluid to pass through the environment and selectively modifiable for the first fluid to pass through one or more of the first heat exchangers; a second fluid circulation means comprising a second fluid flow passage to contain a second fluid, the second fluid circulation means arranged to operate with the environment and the second heat exchangers of the container apparatus pairs; the second fluid flow passage being arranged for the second fluid to pass through the environment and selectively modifiable for the second fluid to pass through one or more of the second heat exchangers; selectively modifying the first fluid flow passage by operation of one or more valves to open and/or close one or more segments of the first fluid flow passage and change a flow path of the first fluid within the first fluid flow passage to include or exclude flow passing through one or more of the first heat exchangers; and selectively modifying the second fluid flow passage by operation of one or more valves to open and/or close one or more segments of the second fluid flow passage and change a flow path of the second fluid within the second fluid flow passage to include or exclude flow passing through one or more of the second heat exchangers.

Other objects and advantages of the present disclosure will become more obvious hereinafter in the specification and drawings.

### FIGURES

The above-mentioned and other features of this disclosure, and the manner of attaining them, will become more apparent and better understood by reference to the following description of embodiments described herein, taken in conjunction with the accompanying drawings, wherein:

FIG. 1 is a schematic view of a hydrogen-transfer heating and/or cooling system in accordance with an embodiment of the present disclosure;

FIG. 2 is an isolated view of a container with a heat exchanger;

FIG. 3 is a schematic view of a hydrogen-transfer heating and/or cooling system configured in accordance with an embodiment of the present disclosure;

FIG. 4 is a table of showing the opened or closed state of various fluid flow valves of the heating and/or cooling system of FIG. 3 to provide various fluid flow path configurations of the circulation fluid flow passages;

FIG. 5 is a schematic view of a hydrogen-transfer heating and/or cooling system configured in accordance with another embodiment of the present disclosure;

FIG. 6 is a schematic view of a hydrogen-transfer heating and/or cooling system of FIG. 5 operated in accordance with another embodiment of the present disclosure; and

FIG. 7 shows an operating concept of a hydrogen-transfer heating and/or cooling system in accordance with an embodiment of the present disclosure.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

While a preferred embodiment(s) of the present invention(s) have been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

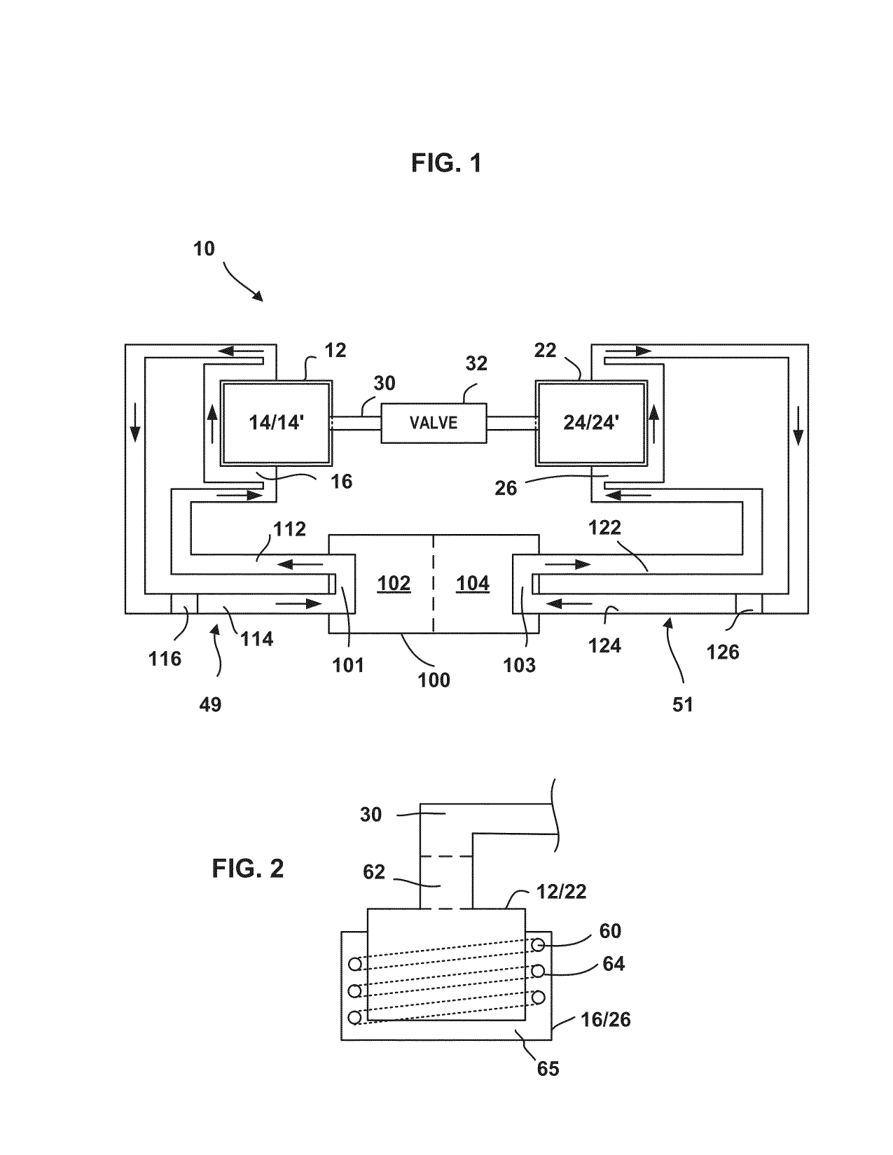

Referring now to the drawings, reference will be made to FIG. 1 where a system for effecting temperature changes in a small human-occupied, man-made environment 100 is illustrated generally by reference numeral 10. In FIG. 1, system 10 is configured for cooling and/or heating environment 100. By way of non-limiting examples, environment 100 can be a garment such as a protective suit worn by an individual, such as a diver, firefighter, chemical or biological “hazmat” worker or military (e.g. soldier) personnel. Environment 100 could also be a small chamber used to temporarily house humans as is the case with dive chambers, submarine rescue chambers or hyperbaric chambers. Environment 100 could also be a larger enclosed containment structure for more permanent use to house humans such a space station in outer space.

Whether used for heating and/or cooling, system 10 generally may include the following: a thermally-conductive container 12 for storing a charged metal hydride 14 therein; a heat exchanger 16 thermally coupled to container 12; a first circulation fluid flow passage 49 coupled to, and in fluid and thermal communication with heat exchanger 16, as well as in thermal (and possibly fluid) communication with environment 100; a thermally-conductive container 22 for storing a metal alloy 24 therein; a heat exchanger 26 thermally coupled to container 22; a first circulation fluid flow passage 51 coupled to, and in fluid and thermal communication with heat exchanger 26, as well as thermal (and possibly fluid) communication with environment 100; a conduit 30 that is open on either end thereof with one open end exposed to metal hydride 14 and the other open end exposed to metal alloy 24; a user-controllable valve 32 disposed in conduit 30 with valve 32 being closed until system 10 is to be used for heating and/or cooling.

Regardless of whether system 10 is used for heating and/or cooling, charged metal hydride 14 may include any metal hydride that stores hydrogen atoms therein at an ambient temperature and a storage pressure that is greater than ambient pressure. Accordingly, container 12 may be understood to be a housing or canister capable of retaining the storage pressure.

Metal alloy 24 may be any metal alloy that is capable of absorbing hydrogen atoms at ambient temperature and a pressure that is less than the pressure at which metal hydride 14 is stored. The lower the hydrogen absorbing pressure of metal alloy 24, the greater the heating or cooling differential produced during operation of system 10.

Metal hydride 14 and metal alloy 24 may be used to heat and/or cool environment 100 via performance of the following reversible chemical equilibrium:

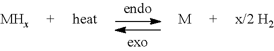

As shown above, with the addition of heat, the hydrogen atom H of the metal hydride MHₓ may be understood to disassociate from the metal hydride MHₓ to produce a metal alloy M and hydrogen gas molecule H₂. Alternatively, when hydrogen gas molecule H₂ and metal alloy M form metal hydride MHₓ, heat is liberated.

More particularly, hydrogen absorption and desorption may be understood as true chemical reactions (chemisorption) and are accompanied by heats of formation which are exothermic for absorption and endothermic for desorption. The reactions showing the heats of formation may be written as follows:

M+H₂→MH₂+heat(out) [1]

M+H₂←MH₂+heat(in) [2]

The direction of the reversible reaction may determined by the pressure of the hydrogen gas. If the pressure is above a certain level (the equilibrium pressure), the reaction proceeds to the right to form a metal hydride; if below the equilibrium pressure, hydrogen is liberated and the metal returns to its original state. The equilibrium pressure, itself, may be understood to depend upon two things, the composition of the alloy and temperature; it increases with increasing temperature and vice versa.

The cooling in the foregoing reactions may be understood to occur in reaction [2] when the pressure is reduced below the equilibrium pressure. Hydrogen desorption is spontaneous and the alloy takes the required heat of formation from its surroundings (e.g. container 12; heat transfer medium surrounding the container 12, such as the heat contained in the heat exchanger or air surrounding the container 12), reducing the temperature of the surroundings.

Container 12/heat exchanger 16 and container 22/heat exchanger 26 may be realized in a variety of ways without departing from the scope of the present disclosure. For example, as illustrated in FIG. 2, each container/heat exchanger combination may be realized by a thermally-conductive container 12 and/or 22 having a fluid flow passage 60, which may be provided by passages formed (bored) in a metal structure 65 or a thermally-conductive conduit 64 encapsulated in a metal structure 65 (metal filled resin) coiled about and in thermal communication with container 12 and/or 22. Container 12 and/or 22 and passage 60/conduit 64 can be individual elements or integrated into a single element. To facilitate the quick installation and removal of container 12 and/or 22 from heat exchangers 16 and/or 26 of system 10 of the present disclosure, a quick connect/disconnect (“Q C/D”) coupling 62 can be used to couple container 12 and/or 22 to conduit 30.

In general, circulation fluid flow passages 49 and 51 may be provided by any fluid-carrying system of pipes, ducts, or other conduits used to transport a fluid medium (e.g., a liquid such as water, or a gas such as air) therein between environment 100 and heat exchanger 16 (in the case of a cooling operation) or heat exchanger 26 (in the case of a heating operation). More specifically, circulation fluid flow passage 49 has a conduit 112 leading from environment 100 to heat exchanger 16, and a conduit 114 leading from heat exchanger 16 to environment 100. Similarly, circulation fluid flow passage 51 has a conduit 122 leading from environment 100 to heat exchanger 26, and a conduit 124 leading from heat exchanger 26 to environment 100. A pump 116 and 126, respectively, can be included along one (or both) of the conduits of each circulation fluid flow passage 49 and/or 51 to facilitate circulation of the fluid medium therein. Coupling/uncoupling of the circulation fluid flow passages 49 and 51 (e.g. conduits) can be accomplished in any of a variety of ways, such as quick connect/disconnect fittings.

Environment 100 may include its own internal pipes, ducts, or other conduits 101 and/or 103 that facilitate the movement of the fluid medium (passed through circulation fluid flow passages 49 and/or 51) there through. For example, if environment 100 is a garment, conduits 101 and/or 103 may comprise a fluid circulation tube integrated into the garment. If environment 100 is a small chamber, conduits 101 and/or 103 could be ductwork for transporting a gaseous fluid medium (e.g., air) there through. If the fluid medium is air, conduits 101 and/or 103 may be vented into environment 100 to allow some of the heated or cooled air to be admitted into environment 100.

In terms of operation, system 10 begins to function when valve 32 is opened. The higher pressure in container 12 immediately drops due to a lower pressure (e.g. the equalization pressure may drop to about 50% of the pressure of container 12 provided that containers 12 and 22 are of equal volume and the volume doubles) thereby allowing hydrogen gas molecules H₂ stored in container 12 at a higher pressure to flow to container 22. In container 22, hydrogen gas molecules H₂ may attach to the surface of the metal alloy 24 and may be understood to break down or dissociate into hydrogen atoms H. The hydrogen atoms H may then penetrate and be absorbed into the interior of the metal alloy 24 to form the metal alloy 24 into metal hydride 24′. In doing so, as the metal alloy 24 is converted to metal hydride 24′, heat is liberated according to the foregoing chemical equilibrium as part of an exothermic reaction. This heat may be then transferred to container 22 and then to heat exchanger 26 to heat the fluid medium therein, and subsequently heat and increase the temperature of environment 100.

After the initial pressure drop due to the transfer of hydrogen gas molecules H₂, additional hydrogen gas molecules H₂ may be desorbed by metal hydride 14 with the application of heat to the metal hydride 14 according to the foregoing chemical equilibrium as part of an endothermic reaction. Here, heat from the environment 100 may be transferred to the fluid medium, then to heat exchanger 16, container 12 and to metal hydride 14. As the heat is absorbed by the metal hydride 14, hydrogen atoms H therein may be desorbed from the interior of the metal hydride 14 and may join or associate to form hydrogen gas molecules H₂, which then detach and flow towards container 22. In doing so, the metal hydride 14 is converted to metal alloy 14′, and the environment 100 may be cooled with the transfer of heat to the metal hydride 14. As such, with respect to FIG. 1, environment 100 may be understood to be cooled and the temperature decreased by virtue of heat within environment 100 being transferred to the fluid medium within circulation system 49 to heat changer 16 and then to container 12. The heat may then be absorbed by the metal hydride 14 in converting the metal hydride 14 to metal alloy 14′.

In light of the foregoing, when environment 100 may be subdivided into separate compartments or sub-environments 102, 104, sub-environment 102 may be cooled and sub-environment 104 may be heated, simultaneously. Such may be desirable, for example, when compartment 104 may be heated for human occupancy, and compartment 102 may be cooled for storage, such as to store food for human consumption.

System 10 may also be used to heat or cool the whole of environment 100. For example, when system 10 may be used to heat all of environment 100, pump 116 may be turned off, or conduits 112 and 114 may be uncoupled from heat exchanger 16. In this manner, heat may no longer be provided to heat exchanger 16 from environment 100, in which case heat from the surrounding ambient environment may be relied upon to provide heat to container 12. Alternatively, when system 10 may be used to cool all of environment 100, pump 126 may be turned off, or conduits 122 and 124 may be uncoupled from heat exchanger 26. In this manner, heat may no longer be provided to environment 100 from heat exchanger 26, in which case heat generated from within container 22 may be merely expelled to the ambient environment.

No power source is required to initiate or maintain the heating and/or cooling operation of system 10. Furthermore, system 10 may be “recharged” by installing new containers 12 and 22 of a pre-charged metal hydride 14 and a metal alloy 24 that can absorb hydrogen at a pressure that is lower than the hydrogen storage pressure of the metal hydride 14. The amount of heating and/or cooling may be increased by using a metal alloy 24 having a lower hydrogen absorption pressure.

Now, while the system 10 of FIG. 1 may operate without a power source, the requirement of installing new reactant containers 12 and 22 to replace the existing (reacted) containers renders system 10 unable to heat and/or cool the environment 100 on a continuous basis for an indefinite time period. In other words, system 10 must be shut-down to change and install new reactant containers, during which time the system 10 does not operate to effect the temperature of the environment 100.

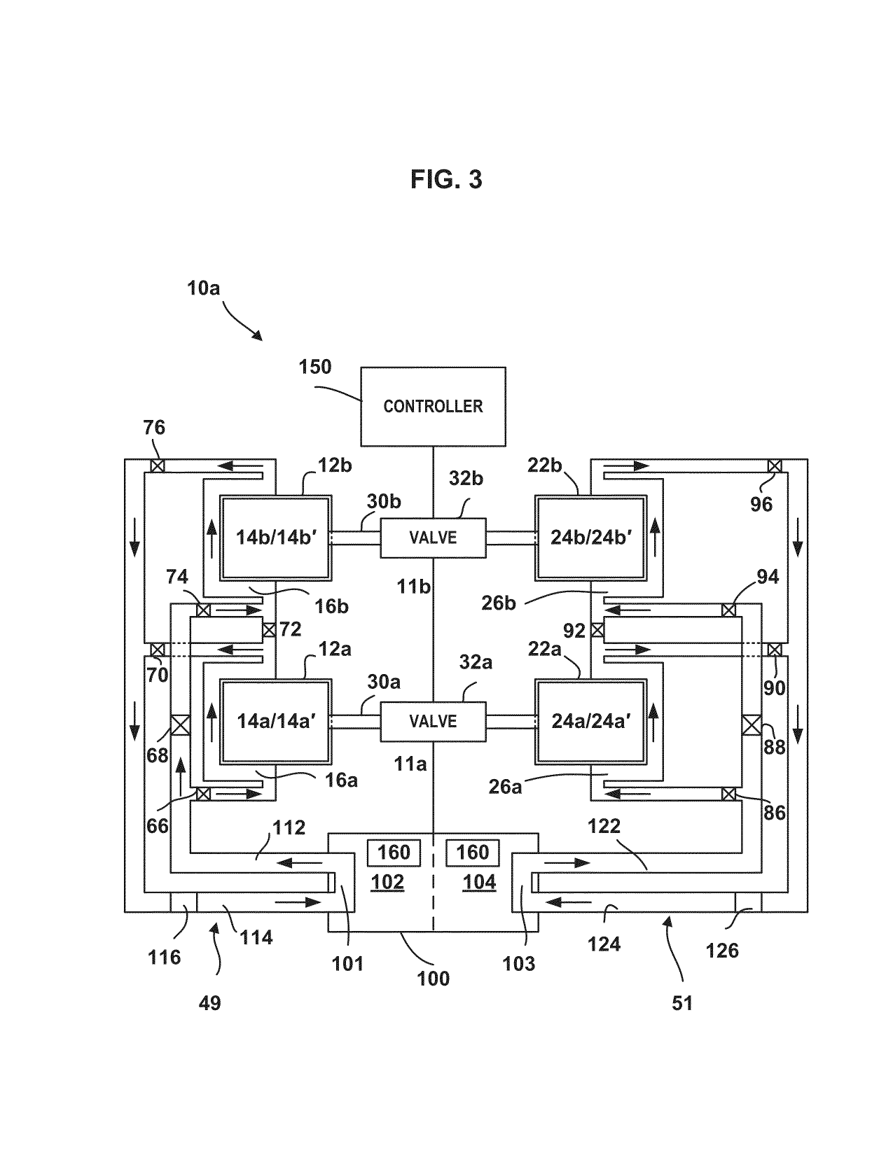

Referring to FIG. 3, there is shown a heating and/or cooling system 10a configured to operate continuously for an indefinite time period, which does not require the system 10a to be shut-down to change the containers 12a, 12b, 22a or 22b.

As shown, system 10a comprises a plurality of container apparatus pairs 11a, 11b. Container apparatus pair 11a comprises a thermally-conductive container 12a for storing a charged metal hydride 14a therein, and a thermally-conductive container 22a for storing a metal alloy 24a therein. A heat exchanger 16a, 26a is thermally coupled to each container 12a, 22a, respectively. Containers 12a, 22a are coupled and in fluid communication with a conduit 30a that is open on either end thereof with one open end exposed to metal hydride 14a and the other open end exposed to metal alloy 24a. A controllable valve 32a is disposed in conduit 30a, with valve 32a being closed until system 10a is to be used for heating and/or cooling.

Similarly, container apparatus pair 11b comprises a thermally-conductive container 12b for storing a charged metal hydride 14b therein, and a thermally-conductive container 22b for storing a metal alloy 24b therein. A heat exchanger 16b, 26b is thermally coupled to each container 12b, 22b, respectively. Containers 12b, 22b are coupled and in fluid communication with a conduit 30b that is open on either end thereof with one open end exposed to metal hydride 14b and the other open end exposed to metal alloy 24b. A controllable valve 32b is disposed in conduit 30b, with valve 32b being closed until system 10a is to be used for heating or cooling.

Similar to the prior embodiment, regardless of whether system 10a is used for heating and/or cooling, charged metal hydride 14a, 14b may be any metal hydride that stores hydrogen atoms therein at an ambient temperature and a storage pressure that is greater than ambient pressure. Accordingly, containers 12a, 12b provide a housing or canister capable of retaining the storage pressure. Such metal hydrides as well as methods of charging or saturating same with hydrogen are well known in the art. Metal alloy 24a, 24b may be any metal alloy that is capable of absorbing hydrogen atoms at ambient temperature and a pressure that is less than the pressure at which metal hydride 14a, 14b is stored. The lower the hydrogen absorbing pressure of metal alloy 24a, 24b, the greater the heating or cooling differential produced during operation of system 10a.

Also similar to the prior embodiment, container 12a/heat exchanger 16a; container 12b/heat exchanger 16b; container 22a/heat exchanger 26a; and container 22b/heat exchanger 24b may be realized in a variety of ways without departing from the scope of the present disclosure, particularly as shown in FIG. 2.

As shown in FIG. 3, heat exchangers 16a, 16b are arranged to operate, via fluid communication, with first fluid circulation means comprising a first circulation fluid flow passage 49. Similarly, heat exchangers 26a, 26b are arranged to operate, via fluid communication, with a second fluid circulation means comprising second circulation fluid flow passage 51. As shown, the two fluid circulation means are isolated from each other.

Circulation fluid flow passages 49 and 51, each of which pass through closed environment 100, may be provided any fluid carrying pipes, ducts, or other conduits used to transport a fluid medium (e.g., a liquid such as water, a gas such as air) therein to provide fluid communication between environment 100 and the heat exchangers.

As shown, a segment of circulation fluid flow passage 49 is provided by a conduit 112 leading from environment 100 to heat exchangers 16a and 16b, and a conduit 114 leading from heat exchangers 16a and 16b to environment 100. A pump 116 can be included along one (or both) of conduits 112 and 114 to facilitate circulation of the fluid medium therein. Similarly, a segment of circulation fluid flow passage 51 is provided by a conduit 122 leading from environment 100 to heat exchangers 26a and 26b, and a conduit 124 leading from heat exchangers 26a and 26b to environment 100. A pump 126 can be included along one (or both) of conduits 122 and 124 to facilitate circulation of the fluid medium therein.

As with the prior embodiment, in many instances, environment 100 may include its own internal pipes, ducts, or other conduits 101, 103 that define a segment of the fluid flow passages 49, 51 and facilitate the movement of the fluid medium there through.

Similar to system 10, system 10a begins to function when valve 32a (and/or valve 32b) is opened. The higher pressure in container 12a (and/or 12b) immediately drops due to a lower pressure (e.g. the equalization pressure may drop to about 50% of the pressure of container 12a and/or 12b provided that containers 12a and 22a and/or 12b and 22b are of equal volume and the volume doubles) thereby allowing hydrogen gas molecules H₂ stored in container 12a (and/or 12b) to flow to container 22a (and/or 22b). In container 22a (and/or 22b), the hydrogen gas molecules H₂ may attach to the surface of the metal alloy 24a (and/or 24b) and may be understood to break down or dissociate into hydrogen atoms H. The hydrogen atoms H then may penetrate and be absorbed into the interior of the metal alloy 24a (and/or 24b) to form the metal alloy 24a (and/or 24b) into metal hydride 24a′ (and/or 24b′). In doing so, as the metal alloy 24a (and/or 24b) is converted to metal hydride 24a′ (and/or 24b′), heat is liberated according to the foregoing chemical equilibrium as part of an exothermic reaction. This heat may be then transferred to container 22a (and/or 22b) and then to heat exchanger 26a (and/or 26b) to heat the fluid medium therein, and subsequently heat and increase the temperature of environment 100.

After the initial pressure drop due to the transfer of hydrogen gas molecules H₂, additional hydrogen gas molecules H₂ may be desorbed by metal hydride 14a (and/or 14b) with the application of heat to the metal hydride 14a (and/or 14b) according to the foregoing chemical equilibrium as part of an endothermic reaction. Here, heat from the environment 100 may be transferred to the fluid medium, then to heat exchanger 16a (and or 16b), container 12a (and/or 12b) and to metal hydride 14a (and/or 14b). As the heat is absorbed by the metal hydride 14a (and/or 14b), hydrogen atoms H therein may be desorbed from the interior of the metal hydride 14a (and/or 14b) and may join or associate to form hydrogen gas molecules H₂, which then detach and flow towards container 22a (and/or 22b). In doing so, the metal hydride 14a (and/or 14b) is converted to metal alloy 14a′ (and/or 14b′), and the environment 100 may be cooled with the transfer of heat to the metal hydride 14a (and/or 14b). As such, with respect to FIG. 3, environment 100 may be understood to be cooled by virtue of heat within environment 100 being transferred to the fluid medium within circulation system 49 to heat changer 16a (and/or 16b) and then to container 12a (and/or 12b). The heat may then be absorbed by the metal hydride 14a (and/or 14b) in converting the metal hydride 14a (and/or 14b) to metal alloy 14a′ (and/or 14b′).

In light of the foregoing, when environment 100 may be subdivided into separate compartments or sub-environments 102, 104, sub-environment 102 may be cooled and sub-environment 104 may be heated, simultaneously. Such may be desirable, for example, when compartment 104 may be heated for human occupancy, and compartment 102 may be cooled for storage, such as to store food for human consumption.

System 10a may also be used to heat or cool the whole of environment 100. For example, when system 10a may be used to heat all of environment 100, pump 116 may be turned off or conduits 112 and 114 may be uncoupled from heat exchanger 16a (and/or 16b). In this manner, heat may no longer be provided to heat exchanger 16a (and/or 16b) from environment 100, in which case heat from the surrounding ambient environment may be relied upon to provide heat to container 12a (and/or 12b). Alternatively, when system 10a may be used to cool all of environment 100, pump 126 may be turned off or conduits 122 and 124 may be uncoupled from heat exchanger 26a (and/or 26b). In this manner, heat may no longer be provided to environment 100 from heat exchanger 26a (and/or 26b), in which case heat generated from within container 22a (and/or 22b) may be merely expelled to the ambient environment.

Now, in addition to the foregoing, various sections of the circulation fluid flow passages 49 and 51 may be opened or closed by various valves to change a configuration of the fluid flow path for the fluid medium in the passages 49 and 51, thus changing the heating and/or cooling of environment 100.

More particularly, as shown in FIG. 3, with respect to circulation fluid flow passage 49, valves 66, 68, 70, 72, 74 and 76 may be operated to change a configuration of the fluid flow path for the fluid medium therein. Furthermore, with respect to circulation fluid flow passage 51, valves 86, 88, 90, 92, 94 and 96 may be operated to change a configuration of the fluid flow path for the fluid medium therein.

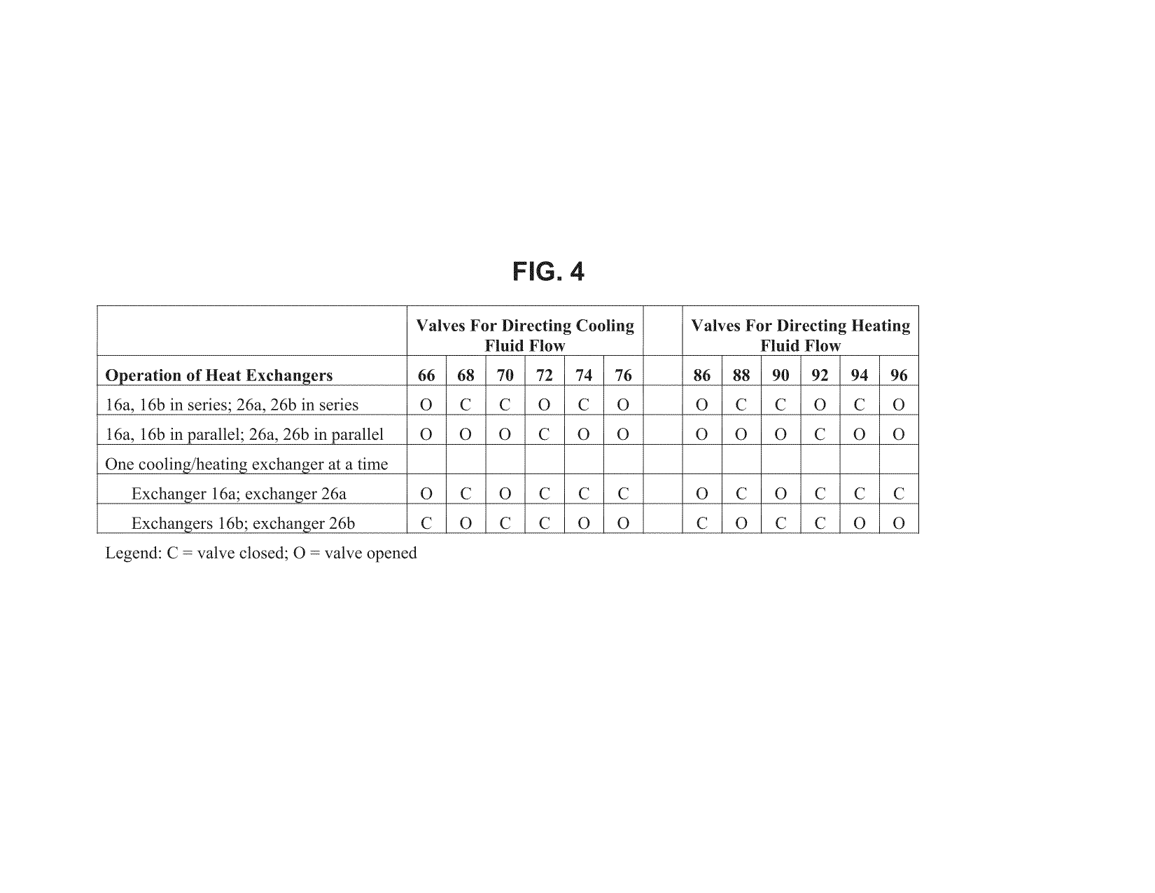

Referring now to FIG. 4, there is shown a table of the opened or closed state of the aforementioned fluid flow valves of the heating and/or cooling system of FIG. 3 to provide various fluid flow path configurations of the circulation fluid flow passages 49, 51.

As shown in FIG. 4, for the fluid medium within circulation fluid flow passage 49 to circulate through heat exchangers 16a and 16b in series (i.e. flow to heat exchanger 16b after flowing to heat exchanger 16a), valves 68, 70 and 74 are closed while valves 66, 72 and 76 are opened. Similarly, for the fluid medium within circulation fluid flow passage 51 to circulate through heat exchangers 26a and 26b in series (i.e. flow to heat exchanger 26b after flowing to heat exchanger 26a), valves 88, 90 and 94 are closed while valves 86, 92 and 96 are opened.

Conversely, for the fluid medium within circulation fluid flow passage 49 to circulate through heat exchangers 16a and 16b in parallel (i.e. divided between both heat exchangers 16a, 16b), valve 72 is closed and all other valves 66, 68, 70, 74 and 76 are opened. Similarly, for the fluid medium within circulation fluid flow passage 51 to circulate through heat exchangers 26a and 26b in parallel (i.e. divided between both heat exchangers 26a and 26b), valve 92 is closed and all other valves 86, 88, 90, 94 and 96 are opened.

In addition to the fluid medium within circulation fluid flow passages 49 and 51 being circulated through heat exchangers 16a, 16b and 26a, 26b in series or in parallel, the valves may be operated such that only one heat exchanger for cooling 16a or 16b, and/or one heat exchanger for heating 26a or 26b is operated at a given time.

For example, for the fluid medium within circulation fluid flow passage 49 to be circulated through heat exchanger 16a without circulating through heat exchanger 16b, valves 68, 72, 74 and 76 are closed while valves 66 and 70 are opened. Alternatively, for the fluid medium within circulation fluid flow passage 49 to be circulated through heat exchanger 16b without circulating through heat exchanger 16a, valves 66, 70 and 72 are closed while valves 68, 74 and 76 are opened.

Similarly for the fluid medium within circulation fluid flow passage 51 to be circulated through heat exchanger 26a without circulating through heat exchanger 26b, valves 88, 92, 94 and 96 are closed while valves 86 and 90 are opened. Alternatively, for the fluid medium within circulation fluid flow passage 51 to be circulated through heat exchanger 26b without circulating through heat exchanger 26a, valves 86, 90 and 92 are closed while valves 88, 94 and 96 are opened.

Thus, from the foregoing, a first heat transfer fluid within circulation fluid flow passage 49 to cool the closed environment 100 after having heat removed there from by one or more of the heat exchangers 16a, 16b is provided, wherein a fluid flow path provided by the circulation fluid flow passage 49 is modifiable by selective operation of a plurality of valves to open and/or close one or more segments of the fluid flow passage 49 and change a flow path for the fluid within the fluid flow passage 49 to flow through any of (1) the plurality of the heat exchangers 16a, 16b in series; (2) the plurality of heat exchangers 16a, 16b in parallel and (3) one or more of the plurality of heat exchangers 16a, 16b.

Additionally, from the foregoing, a second heat transfer fluid within circulation fluid flow passage 51 to heat the closed environment 100 after having heat added there to by one or more of the heat exchangers 26a, 26b is provided, wherein a fluid flow path provided by the circulation fluid flow passage 51 is modifiable by selective operation of a plurality of valves to open and/or close one or more segments of the fluid flow passage 51 and change a flow path for the fluid within the fluid flow passage 51 to flow through any of (1) the plurality of the heat exchangers 26a, 26b in series; (2) the plurality of heat exchangers 26a, 26b in parallel and (3) one or more of the plurality of heat exchangers 26a, 26b.

With the foregoing structure, by being able to alternate use of the metal hydride and metal alloy associated with container apparatus pairs 11a and 11b by control of valves 32a and 32b, respectively, as well as control the flow of heat transfer fluid to the heat exchanger of the appropriate container apparatus pair 11a or 11b, the system 10a may provide continuous, uninterrupted use for an indefinite period of time, particularly as the system 10a does not necessarily need to be shut-down to change the container pairs 12a, 22a and 12b, 22b. In other words, while containers 12a, 22a of container apparatus pair 11a may be being replaced, containers 12b, 22b of container apparatus pair 11b may continue to operate. Alternatively, while containers 12b, 22b of container apparatus pair 11b may be being replaced, containers 12a, 22a of container apparatus pair 11a may continue to operate.

Furthermore, depending on cooling and/or heating requirements for environment 100, one or both of container apparatus pairs 11a, 11b may be utilized at any given time. Thus, when cooling and/or heating demand for environment 100 is particularly high, both of container apparatus pairs 11a, 11b and the associated metal hydride and metal alloy may be utilized for cooling and/or heating. Furthermore, deciding whether to direct heat transfer fluid by a configuration of the circulation fluid flow passages 49 and 51 to flow through the plurality of the heat exchangers 16a, 16b and/or 26a, 26b, respectively, in series or parallel may take into consideration the efficiency and cooling/heating capacity of the two alternatives.

In order to automate the system 10a, the operation of the valves (i.e. opening and closing) may be fully controllable by a controller 150 which includes a microprocessor which receives input from one or more thermostat(s) 160 within environment 100 concerning the actual temperature of the environment 100, compares the actual temperature of the environment 100 to a temperature setting on the thermostat(s) 160, and thereafter controls operation of the remainder of the system 10b to reduce a difference between the actual and set temperatures of the environment 100.

Now, while system 10a may be configured to may provide continuous, uninterrupted cooling and/or heating of environment 100, system 10a is not self-rechargeable. In other words, once the reaction occurring between the metal hydride in containers 12a, 12b and the metal alloy in containers 22a, 22b, respectively, is complete, the containers 12a, 12b, 22a, 22b must be replaced.

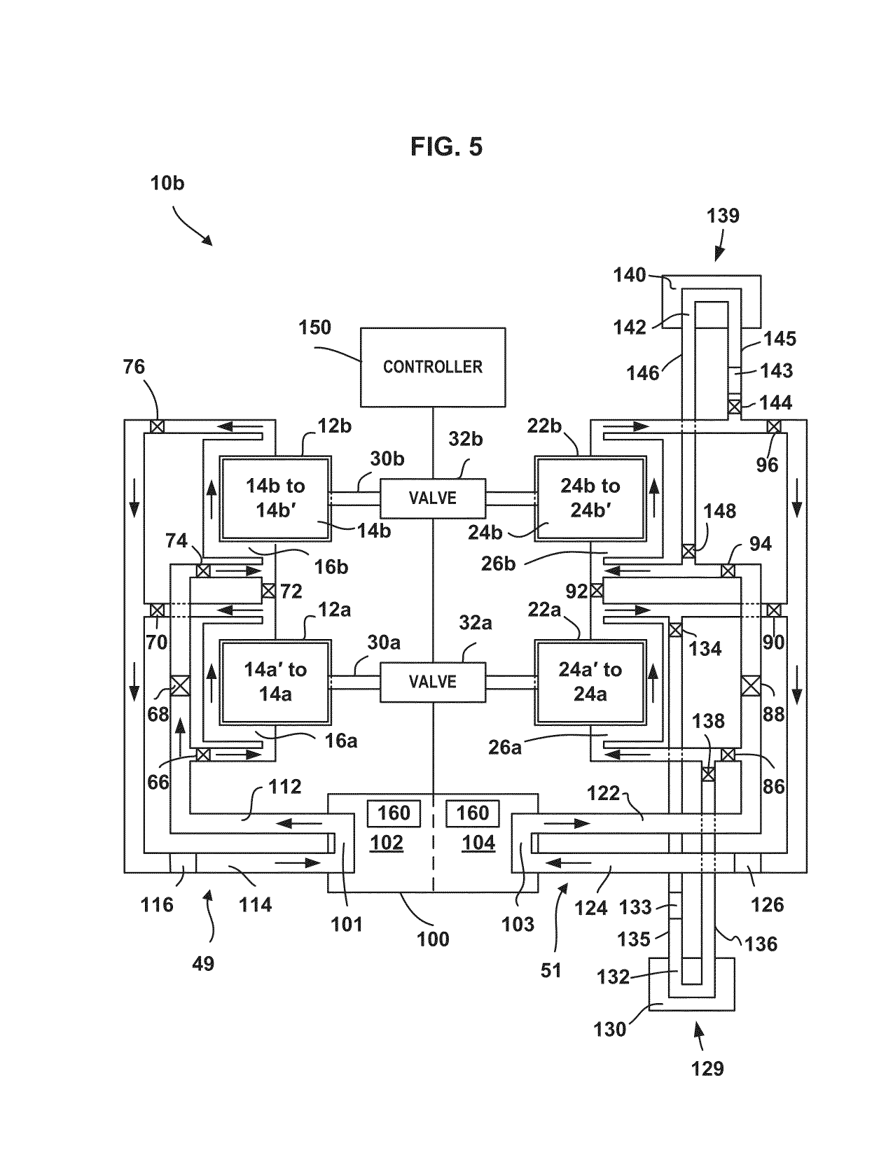

To overcome the aforementioned difficulty, referring now to FIG. 5, system 10b may include at least one heater apparatus which may heat the fluid medium circulating within circulation fluid flow passage 51. More particularly, system 10b may include a plurality of heater apparatuses 129 and 139. As shown, heater apparatus 129 comprises a heater 130, a heat exchanger 132, a pump 133, conduits 135, 136 and valves 134, 138, while heater apparatus 139 comprises a heater 140, a heat exchanger 142, a pump 143, conduits 145, 146 and valves 144, 148.

As set forth above, for the fluid medium within circulation fluid flow passage 51 to be circulated to environment 100 through heat exchanger 26b, without circulating through heat exchanger 26a, valves 86, 90 and 92 are closed while valves 88, 94 and 96 are opened (additionally, in the present embodiment, valves 144 and 148 are also closed). Such may be the situation when only the charged metal hydride 14b of container 12b and the metal alloy 24b of container 22b are being utilized. However, to recharge/regenerate system 10b, during this time system 10b may also be operated such that a portion of the fluid medium within circulation fluid flow passage 51 may also be separately circulated through heat exchanger 26a, albeit not to environment 100.

More particularly, by the opening of valves 134, 138 and the operation of pump 133, a portion of the fluid medium within circulation fluid flow passage 51 may be separately circulated from heat exchanger 26a to conduit 135 leading to heat exchanger 132, at which point the fluid medium may be heated by heater 130. Thereafter the fluid medium may flow in conduit 136 back to heat exchanger 26a. As such, the second fluid flow passage 51 may be arranged to provide a plurality of discrete circulation loops with each loop to contain a portion of the fluid and not be in fluid communication with another loop.

A first circulation loop may be arranged for the fluid therein to pass through the environment 100 and one or more of the second heat exchangers. A second circulation loop may be arranged for the fluid therein to pass through one or more of the second heat exchangers apart from and not of the first circulation loop. The fluid of the second circulation loop may be in thermal communication with a heater 130 to heat the fluid of the second circulation loop.

As set forth above, when valve 32a is opened, the higher pressure in container 12a immediately drops to a lower pressure thereby allowing hydrogen gas molecules H₂ stored in the metal hydride 14a to be released or desorbed in an endothermic reaction. At the same time, the metal alloy 24a absorbs the hydrogen gas molecules H₂ desorbed from the metal hydride 14a in an exothermic reaction.

With the progression of the foregoing reactions, the charged metal hydride 14a may now be understood to convert to metal alloy 14a′, and the metal alloy 24a may be understood to convert to charged metal hydride 24a′.

Referring to FIG. 5, in order to convert the metal alloy 14a′ now in container 12a back to charged metal hydride 14a as well as convert the charged metal hydride 24a′ now in container 22a back to metal alloy 24a, in essence regenerating the original charged metal hydride and metal alloy and reversing the initial reactions, heater 130 may heat the fluid medium which may be transferred to the charged metal hydride 14a in container 22a via heat exchanger 26a. With valve 32a opened, the charged metal hydride 24a′ in container 22a may be heated and hydrogen gas molecules H₂ may be desorbed by metal hydride 24a′ according to the foregoing chemical equilibrium as part of an endothermic reaction. As the heat is absorbed by the metal hydride 24a′, hydrogen atoms H therein may be desorbed from the interior of the metal hydride 24a′ and may join or associate to form hydrogen gas molecules H₂, which then detach and flow towards container 12a. In doing so, the metal hydride 24a′ is converted back to metal alloy 24a.

In container 12a, hydrogen gas molecules H₂ may attach to the surface of the metal alloy 14a′ and may be understood to break down or dissociate into hydrogen atoms H. The hydrogen atoms H may then penetrate and be absorbed into the interior of the metal alloy 14a′ to form the metal alloy 14a′ back into metal hydride 14a. In doing so, as the metal alloy 14a′ is converted to metal hydride 14a, heat is liberated according to the foregoing chemical equilibrium as part of an exothermic reaction. After containers 12a, 22a have been suitably recharged/regenerated, valve 32a may be closed and container 12a, 22a may be allowed to cool before being reused.

Similarly, as set forth above, for the fluid medium within circulation fluid flow passage 51 to be circulated to environment 100 through heat exchanger 26a, without circulating through heat exchanger 26b, valves 88, 92, 94 and 96 are closed while valves 86 and 90 are opened (additionally, in the present embodiment, valves 134 and 138 are also closed). Such may be the situation when only the charged metal hydride 14a of container 12a and the metal alloy 24a of container 22a are being utilized. However, to recharge/regenerate system 10b, during this time system 10b may also be operated such that a portion of the fluid medium within circulation fluid flow passage 51 may also be separately circulated through heat exchanger 26b, albeit not to environment 100.

More particularly, by the opening of valves 144, 148 and the operation of pump 143, a portion of the fluid medium within circulation fluid flow passage 51 may be separately circulated from heat exchanger 26b to conduit 145 leading to heat exchanger 142, at which point the fluid medium may be heated by heater 140. Thereafter the fluid medium may flow in conduit 146 back to heat exchanger 26b.

As set forth above, when valve 32b is opened, the higher pressure in container 12b immediately drops to a lower pressure thereby allowing hydrogen gas molecules H₂ stored in the metal hydride 14b to be released or desorbed in an endothermic reaction. At the same time, the metal alloy 24b absorbs the hydrogen desorbed from the metal hydride 14b in an exothermic reaction.

With the progression of the foregoing reactions, the charged metal hydride 14b may now be understood to convert to metal alloy 14b′, and the metal alloy 24b may be understood to convert to charged metal hydride 24b′.

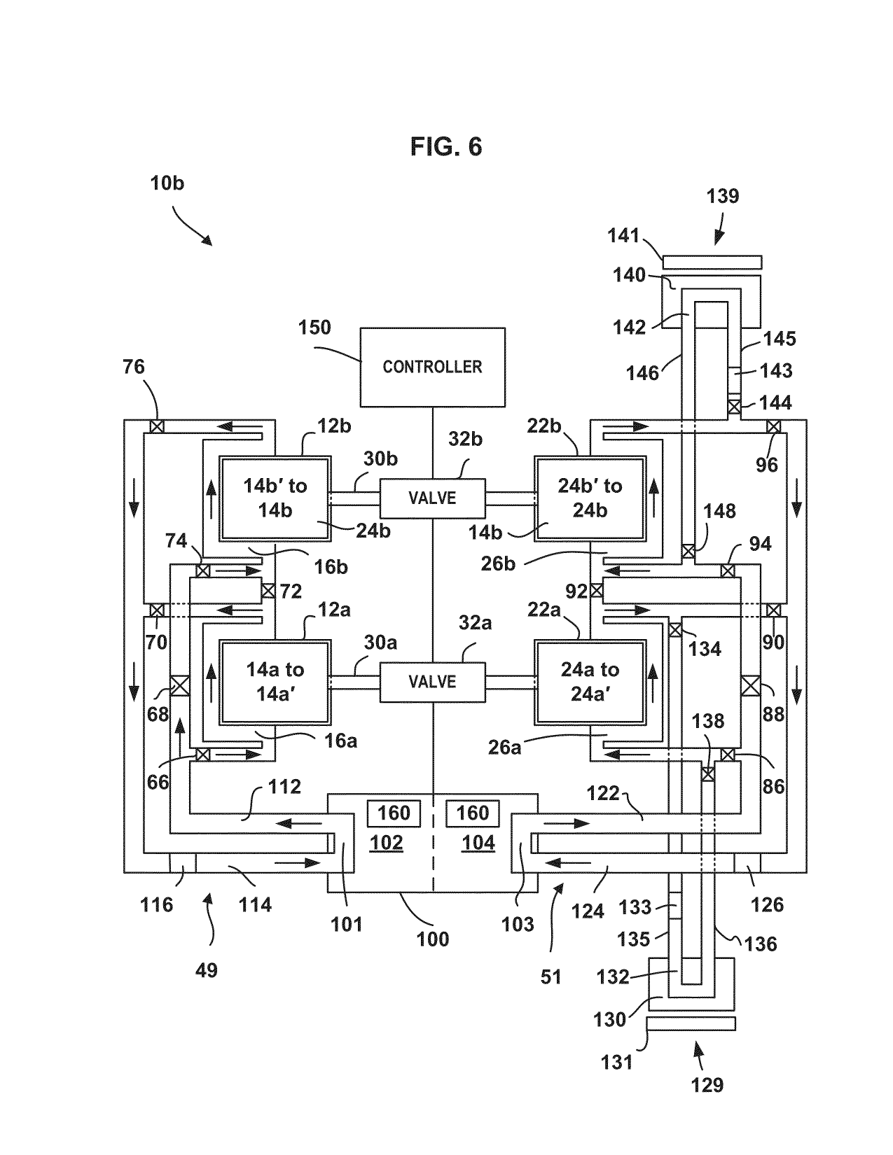

Referring to FIG. 6, in order to convert the metal alloy 14b′ now in container 12b back to the charged metal hydride 14b as well as convert the charged metal hydride 24b′ now in container 22b back to the metal alloy 24b, in essence regenerating the original charged metal hydride and metal alloy and reversing the initial reactions, heater 140 may heat the fluid medium which may be transferred to the charged metal hydride 24b′ in container 22b via heat exchanger 26b. With valve 32b opened, the charged metal hydride 24b′ in container 22b may be heated and hydrogen gas molecules H₂ may be desorbed by metal hydride 24b′ according to the foregoing chemical equilibrium as part of an endothermic reaction. As the heat is absorbed by the metal hydride 24b′, hydrogen atoms H therein may be desorbed from the interior of the metal hydride 24b′ and may join or associate to form hydrogen gas molecules H₂, which then detach and flow towards container 12b. In doing so, the metal hydride 24b′ is converted back to metal alloy 24b.

In container 12b, hydrogen gas molecules H₂ may attach to the surface of the metal alloy 14b′ and may be understood to break down or dissociate into hydrogen atoms H. The hydrogen atoms H may then penetrate and be absorbed into the interior of the metal alloy 14b′ to form the metal alloy 14b′ back into metal hydride 14b. In doing so, as the metal alloy 14b′ is converted to metal hydride 14b, heat is liberated according to the foregoing chemical equilibrium as part of an exothermic reaction. After containers 12b, 22b have been suitably recharged/regenerated, valve 32b may be closed and container 12b, 22b may be allowed to cool before being reused.

A general formula which can be used to determine the minimum amount of container pairs N required for continuous heating/cooling to be provided is N=tᵤₛₑ/t_{regenerate} where t_{regenerate} is the time required for regeneration of one container pair, and tᵤₛₑ is the time that one container pair may provide heating/cooling.

Now, in order to make system 10b self-rechargeable, heaters 130 and 140 preferably comprise solar (thermal) heat collectors, which are configured to heat the fluid medium by collecting solar energy from the sun and transferring the energy as heat to the fluid medium through the heat exchangers 132 and 142, respectively. Since the solar heat provides a renewable (naturally replenished) and indefinite energy source, system 10b may be considered to be operable for an indefinite period of time and thus self-rechargeable. When the solar (thermal) heat collectors are not in use they may be covered by a radiant heat barrier 131, 141, and/or valves 134, 138, 144 and 148 may be closed.

It should also be understood that in addition to of heater apparatuses 129, 139 being configured to operate with heat exchangers 26a, 26b and containers 22a, 22b, respectively, similar heater apparatuses may be configured to operate with heat exchangers 16a, 16b and containers 12a, 12b, respectively if heat from the environment 100 and/or the surrounding ambient environment may not be relied upon to provide heat to container 12a, 12b.

Furthermore, in order to automate the system 10b, the operation of the valves (i.e. opening and closing) may be fully controllable by a controller 150 which includes a microprocessor which receives input from one or more thermostat(s) 160 within environment 100 concerning the actual temperature of the environment 100, compares the actual temperature of the environment 100 to a temperature setting on the thermostat(s) 160, and thereafter controls operation of the remainder of the system 10b to reduce a difference between the actual and set temperatures of the environment 100.

In light of the foregoing, a system to effect temperature change in an environment may be provided, with the system comprising a plurality of container apparatus pairs, each container apparatus pair including a first container apparatus comprising a first container to store a metal hydride therein at a storage pressure greater than ambient pressure, and a first heat exchanger in thermal communication with the first container; a second container apparatus comprising a second container to store a metal alloy therein, the metal alloy being capable of absorbing hydrogen atoms at a pressure less than the storage pressure of the metal hydride, and a second heat exchanger in thermal communication with the second container; a conduit coupled between the first container and the second container, the conduit in communication with the metal hydride and in communication with the metal alloy; a valve disposed in the conduit to control communication between the metal hydride and the metal alloy; a first fluid circulation means comprising a first fluid flow passage to contain a first fluid, the first fluid circulation means arranged to operate with the environment and the first heat exchangers of the container apparatus pairs; the first fluid flow passage being arranged for the first fluid to pass through the environment and selectively modifiable for the first fluid to pass through one or more of the first heat exchangers; a second fluid circulation means comprising a second fluid flow passage to contain a second fluid, the second fluid circulation means arranged to operate with the environment and the second heat exchangers of the container apparatus pairs; the second fluid flow passage being arranged for the second fluid to pass through the environment and selectively modifiable for the second fluid to pass through one or more of the second heat exchangers.

When the valve disposed in the conduit for controlling communication between the metal hydride and the metal alloy is opened, hydrogen atoms desorbed from the metal hydride are transported through said conduit and absorbed by the metal alloy. The hydrogen atoms desorbed from the metal hydride cause an endothermic reaction to reduce the temperature of (cool) the metal hydride, and the hydrogen atoms absorbed by the metal alloy cause an exothermic reaction to increase the temperature of (heat) the metal alloy. This temperature change in the metal hydride and metal alloy may then be transferred to the environment.

The first fluid flow passage may be arranged for the first fluid to remove heat from the environment after heat is removed from the first fluid by one or more of the first heat exchangers, and the second fluid flow passage may be arranged for the second fluid to heat the environment after being heated by one or more of the second heat exchangers.

The first fluid flow passage may be selectively modifiable by operation of a plurality of valves, particularly to open and/or close one or more segments of the first fluid flow passage and change a flow path for the first fluid within the first fluid flow passage. Similarly, the second fluid flow passage may be selectively modifiable by operation of a plurality of valves, particularly to open and/or close one or more segments of the second fluid flow passage and change a flow path of the second fluid within the second fluid flow passage. Operation of all the valves, as well as the pumps, may be computer controlled.

The first fluid flow passage and the second fluid flow passage may be arranged for the first fluid to pass through more than one of the first heat exchangers. The first fluid flow passage and the second fluid flow passage may be arranged for the first fluid to pass through at least two of the first heat exchangers in series or parallel.

The second fluid flow passage may be arranged to provide a plurality of discrete circulation loops with each loop to contain a portion of the second fluid and not be in fluid communication with another loop, and a first circulation loop is arranged for the second fluid therein to pass through the environment and one or more of the second heat exchangers. A second circulation loop may be arranged for the second fluid therein to pass through one or more of the second heat exchangers apart from and not of the first circulation loop. The second fluid of the second circulation loop may be in thermal communication with a heater to heat the second fluid of the second circulation loop. The heater may be operated by a renewable energy source, such as solar energy.

The second fluid circulation means may be further arranged to operate with at least one heater to heat the second fluid contained in the second fluid flow passage. The heater may be operated by a renewable energy source, such as solar energy.

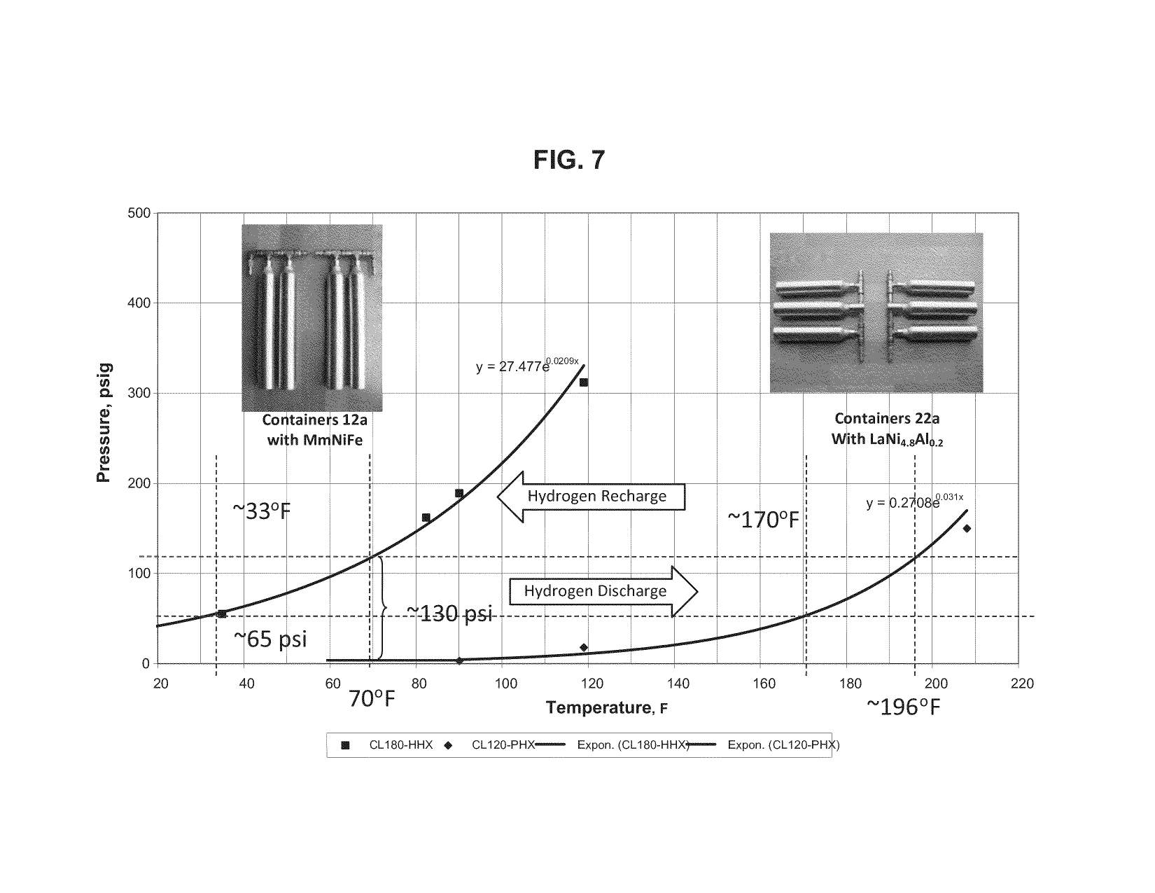

Referring to FIG. 7, there is shown two metal alloys which may be used in accordance with the present disclosure, wherein one metal alloy is mischmetal-nickel-iron (Mm—Ni—Fe) and the other metal alloy is lanthanum-nickel-aluminum (LaNi_{4.8}Al_{0.2}). As shown, each metal alloy may be characterized by a equilibrium pressure-temperature relationship at which hydrogen may be absorbed/desorbed therefrom. These relationships show the expected operating pressures and temperatures as hydrogen cascades from container 12 to container 22.

With reference now to the system of FIGS. 5 and 6, once the mischmetal-nickel-iron (Mm—Ni—Fe) has been charged with hydrogen, such may provide a charged mischmetal-nickel-iron (Mm—Ni—Fe) hydride which may be used for charged metal hydride 14a. Conversely, the metal alloy 24a may be provided by the lanthanum-nickel-aluminum (LaNi_{4.8}Al_{0.2}) metal alloy.

A fluid medium to be used for the transfer of heat between the heat exchangers 16a, 26a and environment may be water, particularly given it is highly availability, low cost and non-toxicity to human life. Furthermore, in order to minimize the complexity of system 10b, it may be considered particularly beneficial to operate the system 10b with the water fluid medium maintained in the liquid phase, so as to avoid having to heat the first or second circulation fluid flow passages 49, 51 (in the event the water may be cold enough to freeze) or pressurize the first or second circulation fluid flow passages 49, 51 (in the event the water may be hot enough to turn to steam).

As shown in FIG. 7, the mischmetal-nickel-iron (Mm—Ni—Fe) metal alloy may exhibit an equilibrium pressure at room temperature (70° F.) of approximately 130 psi. In other words, at 70° F., if the hydrogen pressure applied to the mischmetal-nickel-iron (Mm—Ni—Fe) metal alloy is greater than 130 psi, the mischmetal-nickel-iron (Mm—Ni—Fe) metal alloy will be charged by absorbed hydrogen to provide a mischmetal-nickel-iron (Mm—Ni—Fe) hydride. Conversely, if at 70° F., the pressure is allowed to fall below 130 psi., the mischmetal-nickel-iron (Mm—Ni—Fe) hydride will be discharged and hydrogen desorbed to convert the mischmetal-nickel-iron (Mm—Ni—Fe) hydride back to the mischmetal-nickel-iron (Mm—Ni—Fe) metal alloy.

With reference to FIG. 6, assuming an initial equilibrium temperature of 70° F. when the valve 32a of the hydrogen transfer conduit 30a between the container 12a and container 22a is opened, the pressure differential between these two sets of containers will be approximately 130 psi. Hydrogen will naturally desorb from the charged metal hydride 14a, here the mischmetal-nickel-iron (Mm—Ni—Fe), in container 12a and transfer and be absorbed by the metal alloy 24a, here lanthanum-nickel-aluminum (LaNi_{4.8}Al_{0.2}), in container 22a. As this occurs, the total system pressure will approach 65 psi, causing the container 12a containing the charged metal hydride 14a to become cold (to approximately 33° F.) and the container 22a containing the metal alloy 24a to heat (to approximately 170° F.) until all of the hydrogen has been transferred, at which point the mischmetal-nickel-iron (Mm—Ni—Fe) hydride 14a may now be considered a mischmetal-nickel-iron (Mm—Ni—Fe) alloy 14a′, and the lanthanum-nickel-aluminum (LaNi_{4.8}Al_{0.2}) alloy 24a may now be considered a lanthanum-nickel-aluminum (LaNi_{4.8}Al_{0.2}) hydride 24a′.

To regenerate the reactants, referring now to FIG. 5, the hydrogen of the lanthanum-nickel-aluminum (LaNi_{4.8}Al_{0.2}) hydride 24a′ in container 22a may be desorbed and transferred back to be absorbed by the mischmetal-nickel-iron (Mm—Ni—Fe) alloy 14a′ in container 12a by heating container 22a to a temperature above 196° F. while maintaining the temperature of container 12a below 70° F. This will cause the pressure in container 22a to exceed the pressure in container 12a, causing hydrogen to transfer back to container 12a to be absorbed by the mischmetal-nickel-iron (Mm—Ni—Fe) alloy 14a′ therein. When the regeneration is completed, the transfer conduit 30a can be closed via valve 32a and heating stopped, readying the system 10b to be available for the next operation.

What is claimed is:

1. A system to effect temperature change in an environment, comprising:
a plurality of container apparatus pairs, each container apparatus pair including
a first container apparatus comprising a first container to store a metal hydride therein at a storage pressure greater than ambient pressure, and a first heat exchanger in thermal communication with the first container;
a second container apparatus comprising a second container to store a metal alloy therein, the metal alloy being capable of absorbing hydrogen atoms at a pressure less than the storage pressure of the metal hydride, and a second heat exchanger in thermal communication with the second container;
a conduit coupled between the first container and the second container, the conduit in communication with the metal hydride and in communication with the metal alloy;
a valve disposed in the conduit to control communication between the metal hydride and the metal alloy;
a first fluid circulation means comprising a first fluid flow passage to contain a first fluid, the first fluid circulation means arranged to operate with the environment and the first heat exchangers of the container apparatus pairs;
the first fluid flow passage being arranged for the first fluid to pass through the environment and selectively modifiable for the first fluid to pass through one or more of the first heat exchangers;
a second fluid circulation means comprising a second fluid flow passage to contain a second fluid, the second fluid circulation means arranged to operate with the environment and the second heat exchangers of the container apparatus pairs;
the second fluid flow passage being arranged for the second fluid to pass through the environment and selectively modifiable for the second fluid to pass through one or more of the second heat exchangers.

2. The system of claim 1 wherein:
the first fluid flow passage is selectively modifiable by operation of a plurality of valves.

3. The system of claim 2 wherein:
the first fluid flow passage is selectively modifiable by operation of the valves to open and/or close one or more segments of the first fluid flow passage and change a flow path of the first fluid within the first fluid flow passage.

4. The system of claim 2 wherein:
operation of the valves is computer controlled.

5. The system of claim 1 wherein:
the second fluid flow passage is selectively modifiable by operation of a plurality of valves.

6. The system of claim 5 wherein:
the second fluid flow passage is selectively modifiable by operation of the valves to open and/or close one or more segments of the second fluid flow passage and change a flow path of the second fluid within the second fluid flow passage.

7. The system of claim 5 wherein:
operation of the valves is computer controlled.

8. The system of claim 1 wherein:
the first fluid flow passage is arranged for the first fluid to remove heat from the environment after heat is removed from the first fluid by one or more of the first heat exchangers; and
the second fluid flow passage is arranged for the second fluid to heat the environment after being heated by one or more of the second heat exchangers.

9. The system of claim 1 wherein:
the first fluid flow passage is arranged for the first fluid to pass through more than one of the first heat exchangers.

10. The system of claim 1 wherein:
the first fluid flow passage is arranged for the first fluid to pass through at least two of the first heat exchangers in series.

11. The system of claim 1 wherein:
the first fluid flow passage is arranged for the first fluid to pass through at least two of the first heat exchangers in parallel.

12. The system of claim 1 wherein:
the second fluid flow passage is arranged for the second fluid to pass through more than one of the second heat exchangers.

13. The system of claim 1 wherein:
the second fluid flow passage is arranged for the second fluid to pass through at least two of the second heat exchangers in series.

14. The system of claim 1 wherein:
the second fluid flow passage is arranged for the second fluid to pass through at least two of the second heat exchangers in parallel.

15. The system of claim 1 wherein:
the second fluid flow passage is arranged to provide a plurality of discrete circulation loops with each loop to contain a portion of the second fluid and not be in fluid communication with another loop; and
a first circulation loop is arranged for the second fluid therein to pass through the environment and one or more of the second heat exchangers.

16. The system of claim 15 wherein:
a second circulation loop is arranged for the second fluid therein to pass through one or more of the second heat exchangers apart from and not of the first circulation loop.

17. The system of claim 16 wherein:
the second fluid of the second circulation loop is in thermal communication with a heater to heat the second fluid of the second circulation loop.

18. The system of claim 17 wherein:
the heater is operated by a renewable energy source.

19. The system of claim 18 wherein:
the renewable energy source comprises solar energy.

20. The system of claim 1 wherein:
the second fluid circulation means is further arranged to operate with at least one heater to heat the second fluid contained in the second fluid flow passage.

21. The system of claim 20 wherein:
the heater is operated by a renewable energy source.

22. The system of claim 21 wherein:
the renewable energy source comprises solar energy.

23. The system of claim 1 wherein:
the environment is a closed environment.

24. The system of claim 1 wherein:
the environment is a man-made environment surrounded by an ambient environment.

25. A method to effect temperature change in an environment, comprising:
providing a system to effect temperature change, comprising:
a plurality of container apparatus pairs, each container apparatus pair including
a first container apparatus comprising a first container to store a metal hydride therein at a storage pressure greater than ambient pressure, and a first heat exchanger in thermal communication with the first container;
a second container apparatus comprising a second container to store a metal alloy therein, the metal alloy being capable of absorbing hydrogen atoms at a pressure less than the storage pressure of the metal hydride, and a second heat exchanger in thermal communication with the second container;
a conduit coupled between the first container and the second container, the conduit in communication with the metal hydride and in communication with the metal alloy;
a valve disposed in the conduit to control communication between the metal hydride and the metal alloy;
a first fluid circulation means comprising a first fluid flow passage to contain a first fluid, the first fluid circulation means arranged to operate with the environment and the first heat exchangers of the container apparatus pairs;
the first fluid flow passage being arranged for the first fluid to pass through the environment and selectively modifiable for the first fluid to pass through one or more of the first heat exchangers;
a second fluid circulation means comprising a second fluid flow passage to contain a second fluid, the second fluid circulation means arranged to operate with the environment and the second heat exchangers of the container apparatus pairs;
the second fluid flow passage being arranged for the second fluid to pass through the environment and selectively modifiable for the second fluid to pass through one or more of the second heat exchangers;
selectively modifying the first fluid flow passage by operation of one or more valves to open and/or close one or more segments of the first fluid flow passage and change a flow path of the first fluid within the first fluid flow passage to include or exclude flow passing through one or more of the first heat exchangers; and
selectively modifying the second fluid flow passage by operation of one or more valves to open and/or close one or more segments of the second fluid flow passage and change a flow path of the second fluid within the second fluid flow passage to include or exclude flow passing through one or more of the second heat exchangers.

26. The method of claim 25 further comprising:
arranging the first fluid flow passage for the first fluid to pass through more than one of the first heat exchangers.

27. The method of claim 25 further comprising:
arranging the first fluid flow passage for the first fluid to pass through at least two of the first heat exchangers in series.

28. The method of claim 25 further comprising:
arranging the first fluid flow passage for the first fluid to pass through at least two of the first heat exchangers in parallel.

29. The method of claim 25 further comprising:
arranging the second fluid flow passage for the second fluid to pass through more than one of the second heat exchangers.

30. The method of claim 25 further comprising:
arranging the second fluid flow passage for the second fluid to pass through at least two of the second heat exchangers in series.

31. The method of claim 25 further comprising:
Arranging the second fluid flow passage for the second fluid to pass through at least two of the second heat exchangers in parallel.

32. The method of claim 25 further comprising:
arranging the second fluid flow passage to provide a plurality of discrete circulation loops with each loop to contain a portion of the second fluid and not be in fluid communication with another loop; and
arranging a first circulation loop for the second fluid therein to pass through the environment and one or more of the second heat exchangers.

33. The method of claim 32 further comprising:
arranging a second circulation loop for the second fluid therein to pass through one or more of the second heat exchangers apart from and not of the first circulation loop.

34. The method of claim 33 further comprising:
heating the second fluid of the second circulation loop.

35. The system of claim 34 further comprising:
heating the second fluid of the second circulation loop with solar energy.
